(19) United States
(12) Patent Application Publication
(10) Pub. No.: US 2013/0212206 A1
(43) Pub. Date: Aug. 15, 2013

(54) METHOD OF DISCOVERING IP ADDRESSES OF SERVERS

(71) Applicant: CHING-HSIANG CHAN, Tu-Cheng (TW)

(72) Inventor: CHING-HSIANG CHAN, Tu-Cheng (TW)

(73) Assignee: HON HAI PRECISION INDUSTRY CO., LTD., Tu-Cheng (TW)

(21) Appl. No.: 13/533,982

(22) Filed: Jun. 27, 2012

(30) Foreign Application Priority Data
Feb. 14, 2012 (TW) 101104806

(51) Int. Cl. G06F 15/173; G06F 15/167

(52) U.S. Cl. 709/212; 709/224

(57) ABSTRACT

A method of discovering IP addresses of servers includes: (i1) beginning discovery processes of management modules and initialization processes of servers; (i2) the management modules sending network packages to one of the servers; (i3) the server responding with its IP address to the management modules, if the server receives the network packages of the management modules; (i4) ending the initialization processes of the server; (i5) each such management module storing the IP address in a database, if any of the management modules receive the IP addresses of the server; (i6) the management modules sending network packages to a next one of the servers with a next MAC address, if a next one of the servers with a next MAC address exists; (i7) repeating (i2) through (i5) if and as necessary in respect of the next one of the servers; and (i8) ending the discovery processes of the management modules.

### BACKGROUND

1. Technical Field

The present disclosure relates to a method for automatically discovering Internet Protocol (IP) addresses of servers.

2. Description of Related Art

Plural servers are usually mounted in a rack type chassis in order that, for example, the servers can share a same power supply. The servers are connected to a management module in the chassis, so that the management module can manage the servers. Since the management module must transfer commands to the servers by IP, the management module needs to obtain the IP addresses of the servers. Nowadays, IP addresses are assigned to such servers manually. If a human operator makes a mistake when assigning IP addresses to the servers, the management module is unable to properly manage the servers.

What is needed, therefore, is a means which can overcome the limitations described above.

### BRIEF DESCRIPTION OF THE DRAWINGS

Many aspects of the present disclosure can be better understood with reference to the following drawings. In the drawings, the emphasis is placed upon clearly illustrating the principles of the present disclosure. Moreover, like reference numerals designate corresponding steps throughout the drawings.

FIGS. 1A and 1B are two continuous portions of a single sub-flowchart, and FIG. 2 is another sub-flowchart. The two sub-flowcharts taken together constitute a flowchart, which shows a method of discovering IP addresses of servers according to one embodiment of the present invention. The sub-flowchart of FIGS. 1A and 1B details, in particular, management module-side aspects of the method. The sub-flowchart of FIG. 2 details, in particular, server-side aspects of the method.

### DETAILED DESCRIPTION

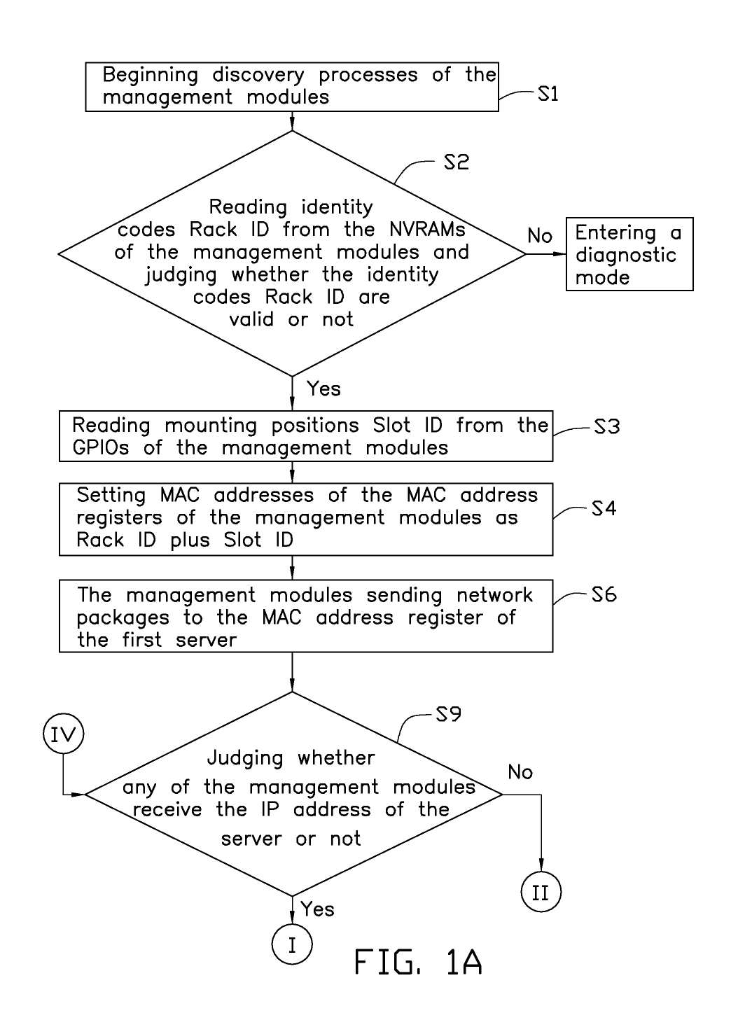

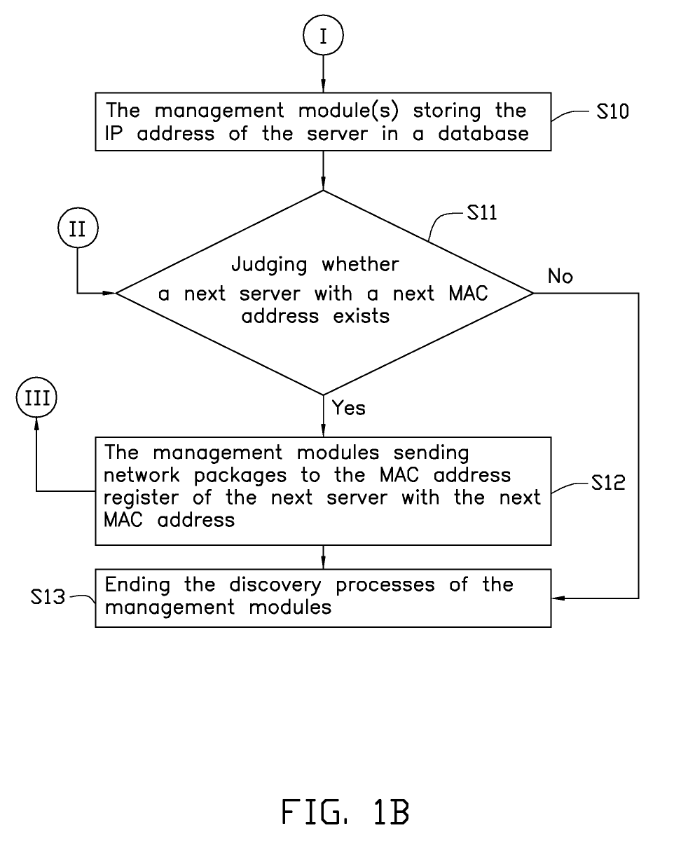

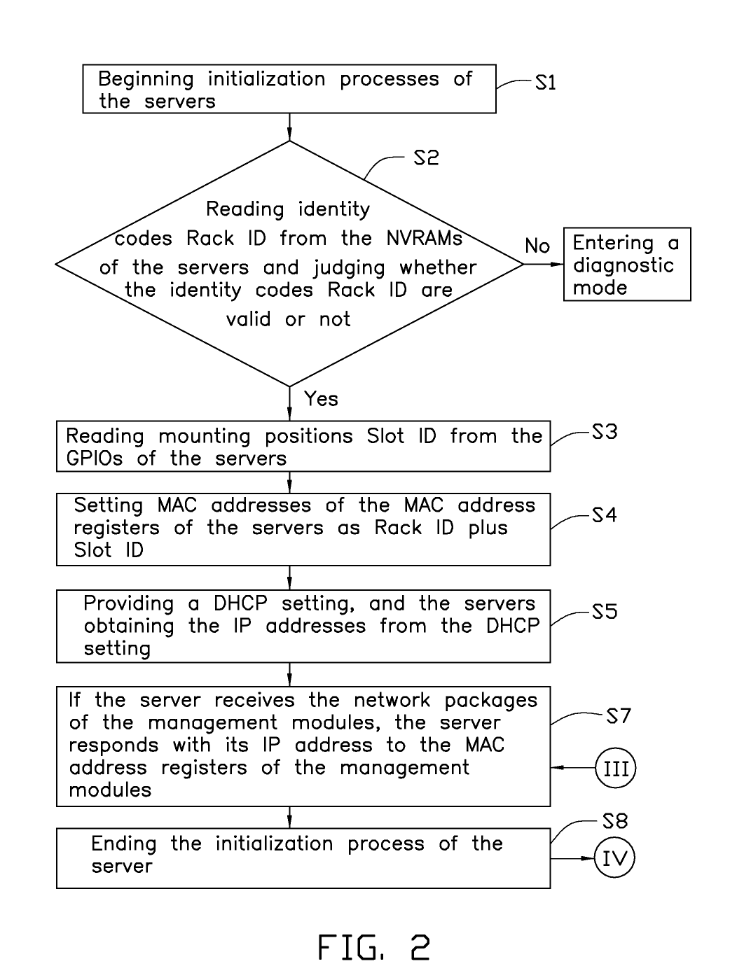

Referring to FIGS. 1A, 1B and 2, a method of discovering IP addresses of servers according to one embodiment is provided. The method is typically performed in a server system.

The server system includes a plurality of servers and a plurality of management modules. The number of servers is m, and the number of management modules is n. Each of the servers and the management modules includes an NVRAM (Non-Volatile Random Access Memory), a GPIO (General Purpose Input Output) port, and a MAC (Media Access Control) address register. An identity code “Rack ID” based on the MAC format is saved in the NVRAM of each of the servers and each of the management modules, after the NVRAM is manufactured. A mounting position “Slot ID” can be read from each of the management modules and from each of the servers by the GPIOs of the management modules and the servers. The values of the identity codes “Rack ID” in all the NVRAMs of the servers and management modules are identical. The values of the mounting positions “Slot ID” of all the servers and management modules are different from each other. The discovery method of IP addresses in servers includes the following steps, in which the management modules and the servers are controlled by software. That is, all the steps of the method are performed by suitable programs of the software automatically.

Step S1 is, beginning discovery processes of the management modules and initialization processes of the servers.

Step S2 is, reading identity codes “Rack ID” from the NVRAMs of the management modules and servers, and then judging whether the values of the identity codes “Rack ID” are valid or not. If the judgment is no, one or more suitable programs of the software indicate that no identity codes “Rack ID” are assigned to the NVRAMs; and then the programs enter a diagnostic mode to assign identity codes “Rack ID” to the NVRAMs. If the judgment is yes, the method proceeds to step S3.

Step S3 is, reading mounting positions “Slot ID” from the GPIOs of the management modules and servers. The mounting positions “Slot ID” of the management modules are in turn set as: [0, 1, . . . n−1]. The mounting positions “Slot ID” of the servers are in turn set as: [n, n+1, . . . n+m−1].

Step S4 is, setting MAC addresses of the management modules and servers as “Rack ID” plus “Slot ID” by executing one or more suitable software programs. The MAC addresses are correspondingly stored in the MAC address registers of the management modules and the servers. Specifically, the MAC addresses of the management modules are in turn set as: Rack ID+[0, 1, . . . n−1]; and the MAC addresses of the servers are in turn set as: Rack ID+[n, n+1, . . . n+m−1].

Step S5 is, providing a DHCP (Dynamic Host Configuration Protocol) setting, wherein the DHCP setting is connected with the servers. The DHCP setting can be another server which is used for providing the servers with IP addresses, respectively. The servers request the IP addresses from the DHCP setting by using the MAC addresses of the servers, and thereby obtain the IP addresses.

Step S6 is, the management modules sending network packages to the MAC address register of the first server with the first MAC address (i.e. Rack ID+n). The network packages are substantially identical, and each network package requests the server to respond with its IP address.

Step S7 is, if the server receives the network packages of the management modules, the server responds with its IP address to the MAC address registers of the management modules.

Step S8 is, ending the initialization process of the server.

Step S9 is, judging whether any of the management modules receive the IP address of the server within a predetermined time period after the network packages are sent. If the judgment is “yes,” the IP address is recorded in the MAC address register(s) of the management module(s) that received the IP address, and then the method proceeds to step S10. If the judgment is “no,” the method proceeds directly to step S11.

Step S10 is, the management module(s) storing the IP address in a database. All the management modules share the same database. Then the method proceeds to step S11.

Step S11 is, judging whether a next server with a next MAC address exists. If the judgment is “yes,” the method proceeds to step S12. If the judgment is “no,” the method proceeds directly to step S13. For example, the first time step S11 is performed, the step involves judging whether a next server with a MAC address Rack ID+n+1 exists.

Step S12 is, the management modules sending network packages to the MAC address register of the next server with the next MAC address. The network packages are substantially identical, and each network package requests the next server to respond with its IP address. Then step S7 through step S11 are repeated as and if necessary.

Step S13 is, ending the discovery processes of the management modules.

By using the above-described discovery method of IP addresses in servers, human error (i.e., a human operator manually assigning IP addresses to the servers by mistake) can effectively be avoided. In addition, because the management modules send network packages to the servers in the same server system, the management modules do not disturb other servers which do not belong to such same server system.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A method of discovering Internet Protocol (IP) addresses of servers, comprising:
(i1) beginning discovery processes of management modules and initialization processes of servers;
(i2) reading identity codes “Rack ID” from the management modules and the servers;
(i3) reading mounting positions “Slot ID” from the management modules and the servers;
(i4) setting Media Access Control (MAC) addresses of the management modules and the servers as “Rack ID” plus “Slot ID;”
(i5) providing a Dynamic Host Configuration Protocol (DHCP) setting, the servers obtaining the IP addresses from the DHCP setting;
(i6) the management modules sending network packages to one of the servers;
(i7) the server responding with its IP address to the management modules, if the server receives the network packages of the management modules;
(i8) ending the initialization processes of the server;
(i9) each such management module storing the IP address in a database, if any of the management modules receive the IP addresses of the server;
(i10) the management modules sending network packages to a next one of the servers with a next MAC address, if a next one of the servers with a next MAC address exists;
(i11) repeating (i6) through (i9) if and as necessary in respect of the next one of the servers; and
(i12) ending the discovery processes of the management modules.

2. The method of claim 1, wherein in (i2), each of the servers and the management modules comprises a Non-Volatile Random Access Memory (NVRAM), the identity code “Rack ID” being assigned to the NVRAM of each of the servers and the management modules.

3. The method of claim 2, wherein in (i3), each of the servers and the management modules comprises a General Purpose Input Output (GPIO) port, the mounting positions “Slot ID” being read from the management modules and the servers by the GPIOs.

4. The method of claim 1, wherein in (i4), each of the servers and the management modules comprises a MAC address register for storing the MAC address therein.

5. The method of claim 2, wherein in (i2), the values of the identity codes “Rack ID” in all the NVRAMs of the servers and management modules are identical.

6. The method of claim 5, wherein in (i3), the values of the mounting positions “Slot ID” of all the servers and management modules are different from each other.

7. The method of claim 1, wherein in (i5), the DHCP setting is connected with the servers, and the servers obtain the IP addresses from the DHCP setting by using their MAC addresses.

8. The method of claim 4, wherein (i9) further comprises: judging whether any of the management modules receive the IP address of the server within a predetermined time period after the network packages are sent; and if the judgment is “yes,” the IP address is recorded in the MAC address registers of each such management modules that received the IP address, whereupon the method proceeds to (i10).

9. The method of claim 8, wherein (i10) further comprises: judging whether a next server with a next MAC address exists; if the judgment is “yes;” the management modules sending network packages to the MAC address register of the next server with the next MAC address, whereupon the method proceeds to (i11); and if the judgment is “no,” the method proceeding directly to (i12).
